(19) United States
(12) Patent Application Publication
(10) Pub. No.: US 2019/0301689 A1
(43) Pub. Date: Oct. 3, 2019

(54) Configurable And Modular Light Fixtures

(71) Applicant: Eaton Intelligent Power Limited, Dublin (IE)

(72) Inventor: Westly Hetrick, Peachtree City, GA (US)

(21) Appl. No.: 15/944,199

(22) Filed: Apr. 3, 2018

(51) Int. Cl. F21S 2/00; F21V 19/00; F21V 15/01

(52) U.S. Cl. CPC F21S 2/005; F21V 15/01; F21V 19/006

(57) ABSTRACT

A lighting system can include a light fixture and module removably connected to the light fixture. The light fixture can include a fixture housing having at least one fixture wall that forms a fixture cavity, where the fixture housing further includes a first connecting feature disposed in the at least one fixture wall. The light fixture can also include a first light fixture component disposed within the fixture cavity and electrically connected to the first connecting feature. The module can include a module housing having at least one device wall and a second connecting feature disposed in the at least one device wall, where the second connecting feature is removably connected to the first connecting feature. The module can also include a module component that is electrically connected to the light fixture component when the first connecting feature and the second connecting feature are connected to each other.

### TECHNICAL FIELD

The present disclosure relates generally to light fixtures, and more particularly to systems, methods, and devices for configurable and modular light fixtures.

### BACKGROUND

Light fixtures and other electrical devices often house one or more components that perform a function of the light fixture or other electrical device. For example, a light fixture can have one or more light sources, one or more sensors, a camera, and a power supply. At times, one or more features (e.g., lighting capability, sensing capability) can be added to or removed from a light fixture.

### SUMMARY

In general, in one aspect, the disclosure relates to a lighting system that includes a light fixture and a first module removably connected to the light fixture. The light fixture can include a fixture housing having at least one fixture wall that forms a fixture cavity, where the fixture housing further includes a first connecting feature disposed in the at least one fixture wall. The light fixture can also include a first light fixture component disposed within the fixture cavity and electrically connected to the first connecting feature. The first module can include a first module housing having at least one first device wall and a second connecting feature disposed in the at least one first device wall, where the second connecting feature is removably connected to the first connecting feature. The first module can also include a first module component that is electrically connected to the first light fixture component when the first connecting feature and the second connecting feature are connected to each other.

In another aspect, the disclosure can generally relate to a light fixture. The light fixture can include a housing having at least one wall that forms a cavity, where the housing further includes a first connecting feature disposed in the at least one wall. The light fixture can also include a first lighting system component disposed within the cavity and electrically connected to the first connecting feature. The first connecting feature can be configured to be removably connected to a first module, where the first module, when connected to the first connecting feature, is connected to the first lighting system component.

In yet another aspect, the disclosure can generally relate to a detachable module for a light fixture. The detachable module can include a housing having at least one wall that forms a cavity, where the housing further includes a connecting feature disposed in the at least one wall. The detachable module can also include a component disposed within the cavity and electrically connected to the connecting feature. The connecting feature can be configured to be detachably connected to a complementary coupling feature of the light fixture. The housing, when connected to the light fixture, can be seamlessly integrated with a light fixture housing of the light fixture.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a light fixture currently used in the art.

FIGS. 2A-2C show various views of a module in accordance with certain example embodiments.

FIGS. 3A and 3B show a base light fixture in accordance with certain example embodiments.

FIGS. 4A and 4B show an integrated light fixture that includes a detachable module coupled to the base light fixture of FIGS. 3A and 3B in accordance with certain example embodiments.

FIGS. 5A and 5B show another base light fixture in accordance with certain example embodiments.

FIGS. 6A and 6B show another integrated light fixture that includes a detachable module coupled to the base light fixture of FIGS. 5A and 5B in accordance with certain example embodiments.

FIGS. 7A and 7B show yet another base light fixture in accordance with certain example embodiments.

FIGS. 8A and 8B shows yet another integrated light fixture that includes a detachable module and the base light fixture of FIGS. 7A and 7B in accordance with certain example embodiments.

FIG. 9 shows a diagram of a system that includes a light fixture and a module in accordance with certain example embodiments.

FIG. 10 shows a computing device in accordance with certain example embodiments.

### DETAILED DESCRIPTION

In general, example embodiments provide systems, methods, and devices for configurable and modular light fixtures. Example configurable and modular light fixtures can be disposed in any of a number of housings (also called enclosures or electrical enclosures herein) of any of a number of electrical devices. While example electrical devices shown and described herein are directed to housings of light fixtures, example embodiments can be used with housings of other electrical devices. Such other electrical devices can include, but are not limited to, a control panel, a computer, a clock, a set top box, a DVD player, a television, a thermostat, a sensor device, a ceiling fan, a smoke detector, a CO monitor, and a motor controller.

The electrical devices for which example embodiments are used can be located in any type (e.g., indoors, outdoors, cold, hot, humid) of environment. In some cases, the example embodiments discussed herein can be used in any type of hazardous environment, including but not limited to an airplane hangar, a drilling rig (as for oil, gas, or water), a production rig (as for oil or gas), a refinery, a chemical plant, a power plant, a mining operation, a wastewater treatment facility, and a steel mill. A user may be any person that interacts with electrical devices. Examples of a user may include, but are not limited to, an engineer, an electrician, an instrumentation and controls technician, a mechanic, an operator, a consultant, an inventory management system, an inventory manager, a foreman, a labor scheduling system, a contractor, a homeowner, a business owner, and a manufacturer's representative.

The example configurable and modular light fixtures (including the detachable modules) described herein can be made of one or more of a number of suitable materials to allow the electrical device and/or other associated components of a system to meet certain standards and/or regulations while also maintaining reliability in light of the one or more conditions under which the electrical device and/or other associated components of the system can be exposed. Examples of such materials can include, but are not limited to, aluminum, stainless steel, fiberglass, glass, plastic, potting material, ceramic, and rubber.

Example configurable and modular light fixtures (or portions thereof) described herein can be made from a single piece (as from a mold, injection mold, die cast, or extrusion process). In addition, or in the alternative, example configurable and modular light fixtures (or portions thereof) can be made from multiple pieces that are mechanically coupled to each other. In such a case, the multiple pieces can be mechanically coupled to each other using one or more of a number of coupling methods, including but not limited to epoxy, welding, fastening devices, detents, compression fittings, mating threads, snap fittings, friction fittings, and slotted fittings. One or more pieces that are mechanically coupled to each other can be coupled to each other in one or more of a number of ways, including but not limited to fixedly, hingedly, removeably, slidably, and threadably.

Components and/or features described herein can include elements that are described as connecting, coupling, fastening, securing, retaining, abutting against, or other similar terms. Such terms are merely meant to distinguish various elements and/or features within a component or device and are not meant to limit the capability or function of that particular element and/or feature. For example, a feature described as a “connecting feature” can connect, couple, secure, fasten, abut against, and/or perform other functions aside from merely connecting. Further, a connecting feature can provide mechanical and electrical connection in some cases.

A connecting feature (including a complementary connecting feature) as described herein can allow one or more components and/or portions of an example detachable module to become mechanically coupled, directly or indirectly, to the housing of a light fixture (or other electrical device). Such a connecting feature can also allow one or more components and/or portions of an example detachable module to become electrically coupled, directly or indirectly, to one or more components (e.g., a controller) disposed within the housing of the light fixture (or other electrical device). A connecting feature can include, but is not limited to, a portion of a hinge, an aperture, a recessed area, a protrusion, a slot, a spring clip, a male connector end (or portion thereof), a female connector end (or portion thereof), a tab, a detent, and mating threads. The housing of an example light fixture can be coupled to an example detachable module by the direct use of one or more connecting features.

In addition, or in the alternative, an example detachable module can be coupled to the housing of an example light fixture (or other electrical device) using one or more independent devices that interact with one or more connecting features disposed on the detachable module and/or the housing of the light fixture. Examples of such devices can include, but are not limited to, a pin, a male connector end, a female connector end, a hinge, epoxy, adhesive, tape, welding, a fastening device (e.g., a bolt, a screw, a rivet), and a spring. One connecting feature described herein can be the same as, or different than, one or more other connecting features described herein. A complementary connecting feature as described herein can be a connecting feature that mechanically couples, directly or indirectly, with another connecting feature. A connecting feature can be made of, at least in part, an electrically-conductive material.

In the foregoing figures showing example embodiments of configurable and modular light fixtures, one or more of the components shown may be omitted, repeated, and/or substituted. Accordingly, example embodiments of configurable and modular light fixtures should not be considered limited to the specific arrangements of components shown in any of the figures. For example, features shown in one or more figures or described with respect to one embodiment can be applied to another embodiment associated with a different figure or description.

Example configurable and modular detachable modules for light fixtures (or other electrical devices) described herein can be used to serve one or more of a number of functions used to operate the light fixtures (or other electrical devices) in or on which they are disposed. Such functions can include, but are not limited to, light emission, image capture, control, power supply, power storage, sensing, a safety barrier, and timing.

In certain example embodiments, electrical devices having example embodiments are subject to meeting certain standards and/or requirements. For example, the National Electric Code (NEC), the National Electrical Manufacturers Association (NEMA), the International Electrotechnical Commission (IEC), Underwriters Laboratories (UL), the Federal Communication Commission (FCC), the Illuminating Engineering Society (IES), and the Institute of Electrical and Electronics Engineers (IEEE) set standards as to electrical enclosures, wiring, and electrical connections. Use of example embodiments described herein meet (and/or allow a corresponding device to meet) such standards when required. In some (e.g., PV solar) applications, additional standards particular to that application may be met by the electrical enclosures described herein.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three or four digit number and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of configurable and modular light fixtures (including detachable modules) will be described more fully hereinafter with reference to the accompanying drawings, in which example embodiments of configurable and modular light fixtures are shown. Configurable and modular light fixtures may, however, be embodied in many different forms and should not be construed as limited to the example embodiments set forth herein. Rather, these example embodiments are provided so that this disclosure will be thorough and complete, and will fully convey the scope of configurable and modular light fixtures to those of ordinary skill in the art. Like, but not necessarily the same, elements (also sometimes called components) in the various figures are denoted by like reference numerals for consistency.

Terms such as “first”, “second”, “top”, “bottom”, “front”, “rear”, “side”, “end”, “left”, “right”, “outer”, “outward”, and “within” are used merely to distinguish one component (or part of a component or state of a component) from another. Such terms are not meant to denote a preference or a particular orientation, and are not meant to limit embodiments of configurable and modular light fixtures. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

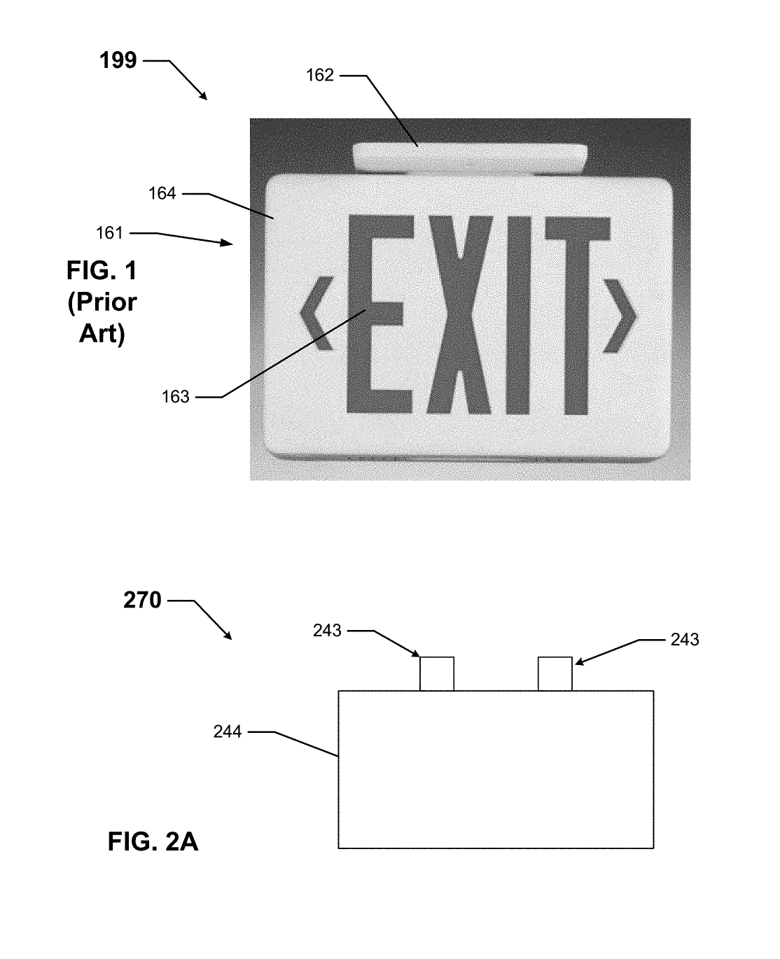

FIG. 1 shows a light fixture 199 currently used in the art. The light fixture 199 in this case is an exit sign that includes a base 162 and a body 161. The base 162 is attached to the body 161 and is configured to be attached to a surface (e.g., a ceiling, a beam, a wall, a pillar). The body 161 can include a housing 164, one or more light sources 163, and one or more other components (e.g., a controller, a power module) disposed within the housing 164 and hidden from view. The light fixture 199 is not configurable or modular. In other words, the light fixture 199 currently known in the art has known components that are not substitutable or upgradable. If a component fails or if the light fixture 199 no longer has the desired capabilities, the entire light fixture 199 is replaced.

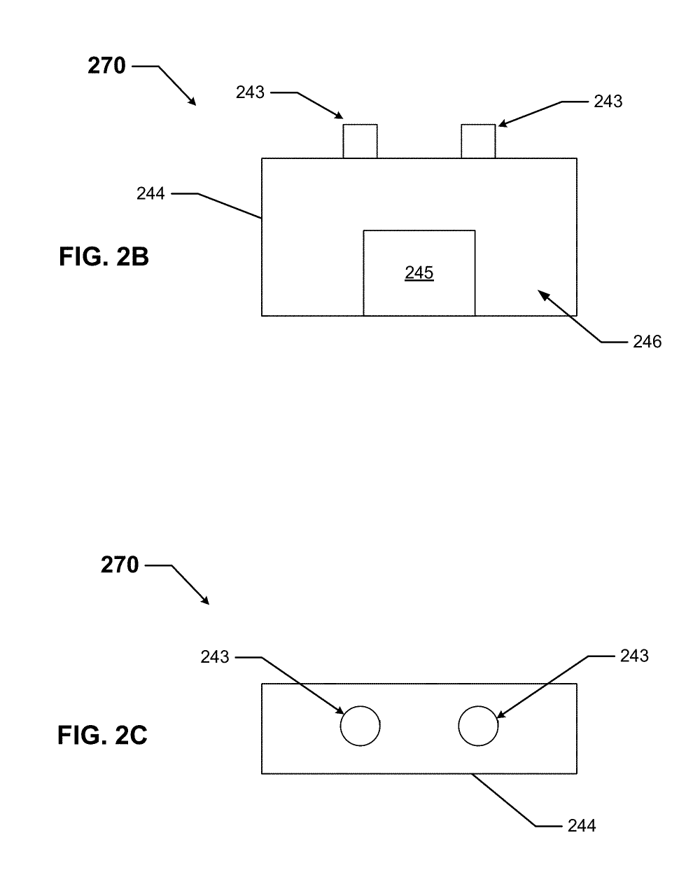

FIGS. 2A-2C show various views of a detachable module 270 in accordance with certain example embodiments. Specifically, FIG. 2A shows a side view of the detachable module 270. FIG. 2B shows a cross-sectional side view of the detachable module 270. FIG. 2C shows a top view of the detachable module 240. Referring to FIGS. 1-2C, the example detachable module 270 of FIGS. 2A-2C can include a housing 244 and one or more connecting features 243 that extend from (or are otherwise integrated with) the housing 244.

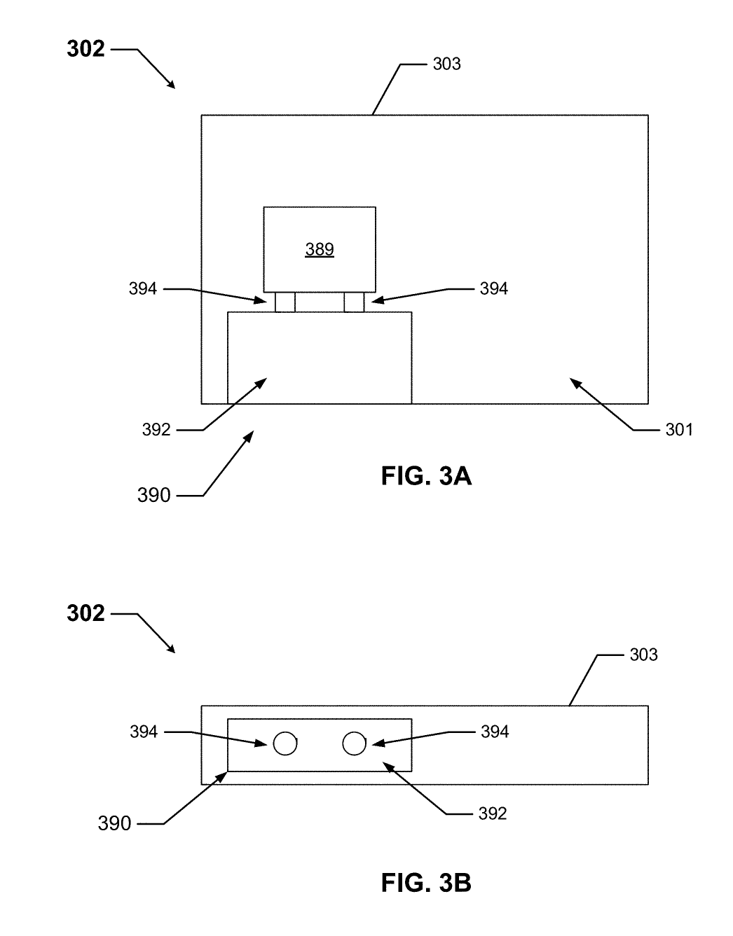

Each connecting feature 243 is configured to allow the detachable module 270 to mechanically and, in many cases, electrically couple to a base light fixture (e.g., base light fixture 302 of FIGS. 3A and 3B, described below). When a detachable module 270 includes multiple connecting features 243, one connecting feature 243 can be the same as, or different than, one or more of the other connecting features 243. Each connecting feature 243 is configured (e.g., in terms of shape, in terms of size, in terms of location on the housing 244 of the detachable module 270, in terms of its features) to couple to a complementary connecting feature disposed in or on the housing of a light fixture (or other electrical device).

The location of each connecting feature 243 relative to the housing 244 can vary. For example, in this case, the two connecting features 243 are disposed on and extend away from the top surface of the housing 244. Alternatively, a connecting feature 243 can be disposed on any other surface (e.g., front surface, a side surface) of the housing 244. A connecting feature 243 can also be disposed on a joint, such as where the top surface and the front surface of the housing 244 intersect. A connecting feature 243 can be an extension of the housing 244 (as shown in FIGS. 2A-2C), recessed into the housing 244, integrated with the housing 244, seamless with the housing 244, and/or otherwise disposed relative to the housing 244.

The housing 244 of the detachable module 270 can include one or more walls form a cavity 246. The cavity 246 formed by the walls of the housing 244 can have disposed therein one or more components 245 related to the purpose of the detachable module 270. A component 245 can be completely enclosed within cavity 246 of the housing 244. Alternatively, at least part of the component 245 can form an outer surface of the housing 244 in conjunction with one or more walls of the housing 244. For example, as shown in FIG. 2B, while most of the component 245 is disposed within the cavity 246, the bottom portion of the component 245 helps to form the bottom surface of the housing 244 of the detachable module 270.

A component 245 can include one or more devices and/or one or more discrete components. Examples of such devices and/or discrete components of a component 245 can include, but are not limited to, a sensor, a camera, a light source, a repeater, a resistor, a circuit board, an integrated circuit, a capacitor, a diode, a transformer, an inverter, a converter, and an inductor. A component 245 can perform one or more functions that can be integral to, or unrelated to, the operation of a light fixture or other electrical device. Examples of such functions can include, but are not limited to, light emission, image capture, control, power supply, power storage, sensing, a safety barrier, and timing.

The housing 244 can have any of a number of shapes and/or sizes. Examples of shapes of the housing 244 can include, but are not limited to, a cube, a cuboid, a rectangular prism, a sphere, and a random three-dimensional shape. In some cases, the shape and size of the housing 244 is configured to complement a connecting assembly (described below) of a housing of an electrical device (e.g., a light fixture) so that the detachable module 270 is substantially seamlessly integrated with the housing of the electrical device when the detachable module 270 is coupled to the housing of the electrical device.

FIGS. 3A and 3B show a base light fixture 302 (a type of electrical device) in accordance with certain example embodiments. Specifically, FIG. 3A shows a cross-sectional side view of the base light fixture 302. FIG. 3B shows a bottom view of the base light fixture 302. Referring to FIGS. 1-3B, the example base light fixture 302 of FIGS. 3A and 3B can include a housing 303 and one or more connecting assemblies 390 that are recessed into (or are otherwise integrated with) the housing 303. The term “base” for the base light fixture 302 of FIGS. 3A and 3B conveys that the light fixture 302 is capable of connecting to one or more detachable modules without actually being connected to any detachable modules at that point in time.

Each connecting assembly 390 is configured to connect to and/or receive a detachable module (e.g., detachable module 270). A connecting assembly 390 can include one or more connecting features 394 and, in some cases, a receiving cavity 392. The optional receiving cavity 392 of a connecting assembly 390 can have a shape and size to receive some or all of a housing (e.g., housing 244) of a detachable module (e.g., detachable module 270). The receiving cavity 392 can be recessed relative to the other outer surfaces (e.g., bottom surface) of the housing 303 of the base light fixture 302. Since the receiving cavity 392 of a connecting assembly 390 is exposed to an ambient environment, the receiving cavity 392 is formed by one or more walls of the housing 303 and can include some of the outer surfaces of the housing 303.

When a connecting assembly 390 of a base light fixture 302 includes multiple connecting features 394, one connecting feature 394 can be the same as, or different than, one or more of the other connecting features 394. Each connecting feature 394 is configured (e.g., in terms of shape, in terms of size, in terms of location of the connecting assembly 390 of the base light fixture 302, in terms of its features) to connect to a complementary connecting feature (e.g., connecting feature 243) of a detachable module (e.g., detachable module 270).

The location of each connecting feature 394 relative to the housing 303 (which can include the receiving cavity 392) can vary. For example, in this case, the two connecting features 394 are disposed on a top surface that forms the receiving cavity 392 and are recessed into the housing 303. Alternatively, a connecting feature 394 can be disposed on any other surface (e.g., front surface, a side surface) of the housing 303 and/or any other surface that forms the receiving cavity 392. A connecting feature 394 can also be disposed on a joint, such as where the top surface and the front surface that forms the receiving cavity 392 intersect. A connecting feature 394 can be an extension of the housing 303, recessed into the housing 303 (as shown in FIGS. 3A and 3B), integrated with the housing 303, seamless with the housing 303, and/or otherwise disposed relative to the housing 303 of the base light fixture 302.

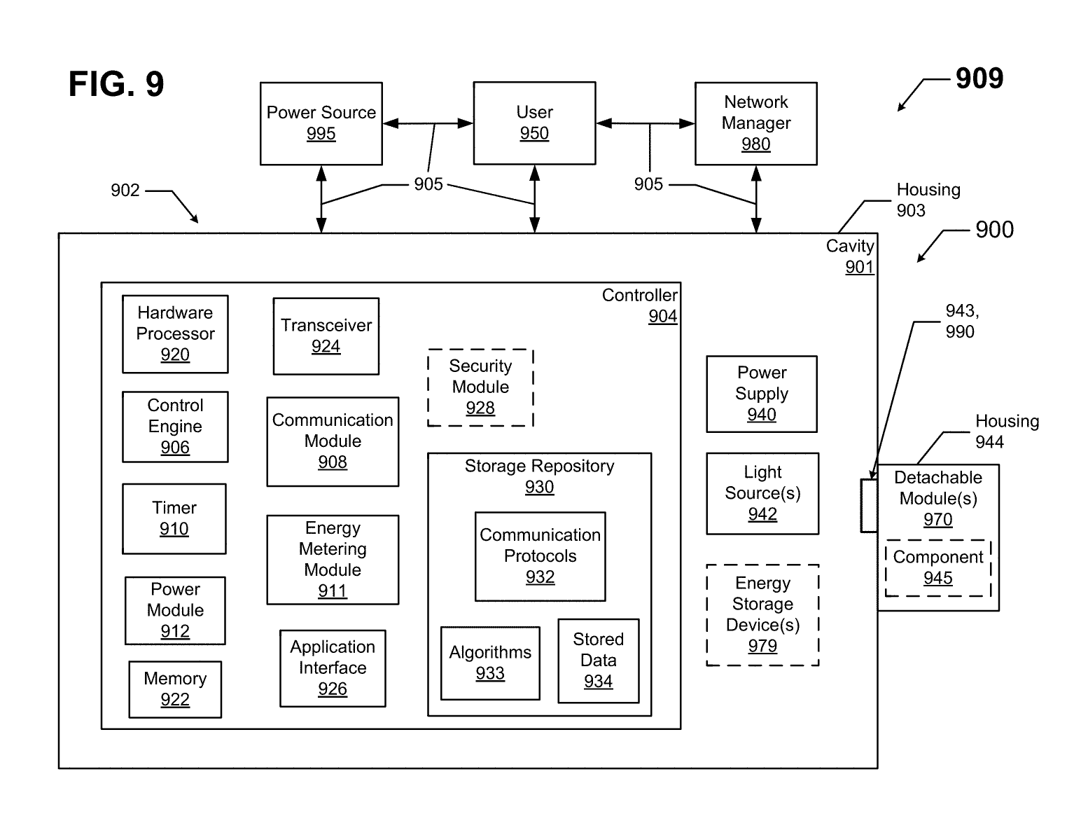

The housing 303 of the base light fixture 302 can include one or more walls that form a cavity 301. The cavity 301 formed by the walls of the housing 303 can have disposed therein one or more components 389 related to the operation of the base light fixture 302. These components 389 can be completely enclosed within cavity 301 of the housing 303. Alternatively, at least part of such a component can form an outer surface of the housing 303 in conjunction with one or more walls of the housing 303. As still another example, such a component 389 can extend away from the housing 303. For example, as shown in FIG. 3A, the component 389 is a controller 389 and is disposed entirely within the cavity 301. In some cases, as in this example, such a component 389 can be directly coupled (connected) to one or more of the connecting features 394 of the connecting assembly 390. Examples of these components 389 can include, but are not limited to, the controller 389, a power supply, a light source, and an energy storage device. More details about these components are provided below with respect to FIG. 9.

The housing 303 can have any of a number of shapes and/or sizes. Examples of shapes of the housing 303 can include, but are not limited to, a cube, a cuboid, a rectangular prism, a sphere, and a random three-dimensional shape. In some cases, the shape and size of the housing 303 is configured to complement one or more coupling features (e.g., coupling features 243) (and, in some cases, some or all of a housing) of a detachable module (e.g., detachable module 270) so that the detachable module is substantially seamlessly integrated with the housing of the base light fixture 302 when the detachable module is coupled to the base light fixture 302.

In some cases, when the base light fixture 302 is disposed on its own, without a detachable module (e.g., detachable module 270), there can be a “blank” or “cover” that covers the connecting assembly 390. Such a “blank” or “cover” can be used to make the housing 303 appear continuous and featureless in the absence of a detachable module. Further, such a “blank” or “cover” can also occupy some or all of the connecting assembly 390 (e.g., the receiving cavity 392, one or more of the connecting features 394).

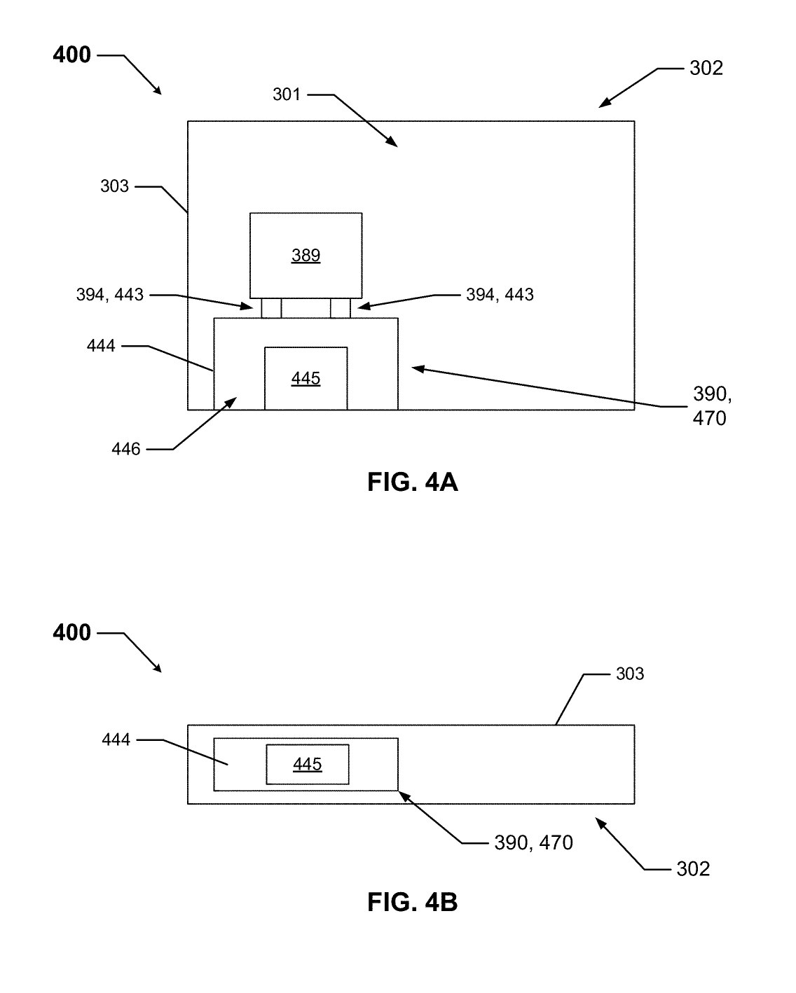

FIGS. 4A and 4B show an integrated light fixture 400 that includes a detachable module 470 coupled to the base light fixture 302 of FIGS. 3A and 3B in accordance with certain example embodiments. Specifically, FIG. 4A shows a cross-sectional side view of the integrated light fixture 400. FIG. 4B shows a bottom view of the integrated light fixture 400. Referring to FIGS. 1-4B, the detachable module 470 of FIGS. 4A and 4B can be substantially the same as the detachable module 270 discussed above with respect to FIGS. 2A-2C. For example, the detachable module 470 of FIGS. 4A and 4B can include a housing 444, one or more (in this case, two) connecting features 443 that extend from the top wall of the housing 444, and a component 445 disposed within a cavity 446 formed by the housing 444.

With the integrated light fixture 400, the detachable module 470 is connected to (coupled to) the connecting assembly 390 of the base light fixture 302. When this occurs, as shown in FIGS. 4A and 4B, the housing 444 of the detachable module 470 is disposed within the cavity 392 of the connecting assembly 390 in such a way that the bottom surface of the housing 444, and also in this case the bottom surface of the component 445, of the detachable module 470 are substantially planar with the bottom surface of the housing 303 of the base light fixture 302.

Also, when the detachable module 470 is connected to (coupled to) the connecting assembly 390 of the base light fixture 302, the component 445 of the detachable module 470 can become electrically coupled, using one or more of the coupling features 443 of the detachable module 470 and one or more coupling features 394 of the connecting assembly 390 of the base light fixture 302, to the component 389 (e.g., a controller) disposed in the housing 303 of the base light fixture 302.

Connecting and/or unconnecting the detachable module 470 and the base light fixture 302 from each other can be done by a user (e.g., user 950 of FIG. 9 below) with or without the use of tools. Also, as discussed below, the controller 389 of the base light fixture 302 can be configured to automatically recognize the component 445 of the detachable module 470, commission the component 445 (if necessary), communicate with the component 445, and provide the necessary voltage and/or instructions for the component 445 to seamlessly operate, whether in furtherance of the operation of the integrated light fixture 400 or for some other function or system.

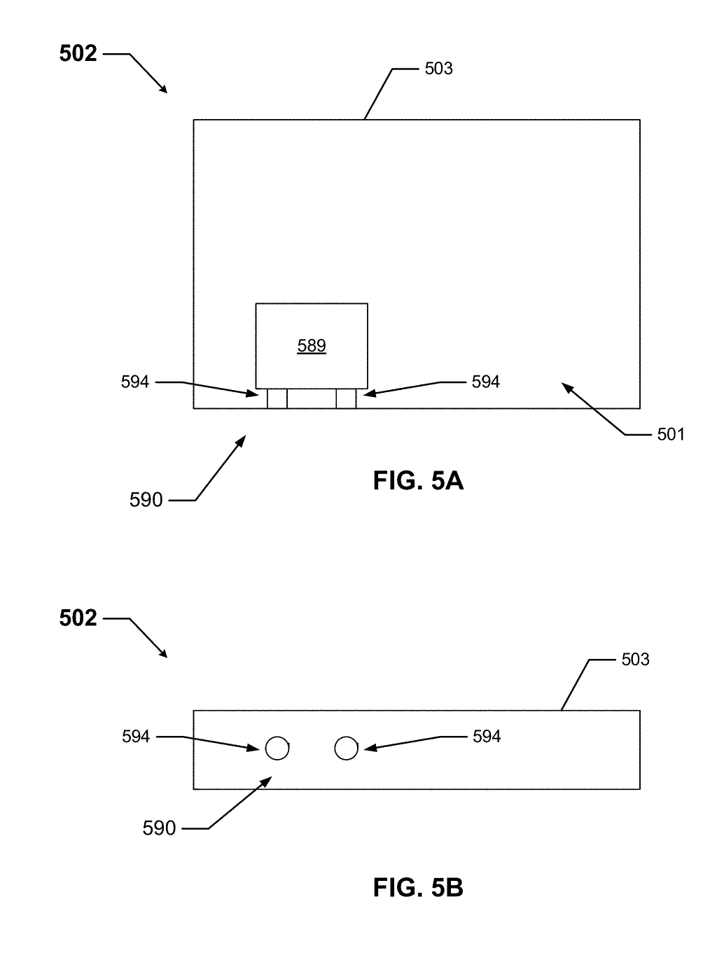

FIGS. 5A and 5B show another base light fixture 502 in accordance with certain example embodiments. Specifically, FIG. 5A shows a cross-sectional side view of the base light fixture 502. FIG. 5B shows a bottom view of the base light fixture 502. Referring to FIGS. 1-5B, the example base light fixture 502 of FIGS. 5A and 5B can include a housing 503 and one or more connecting assemblies 590 that are recessed into (or are otherwise integrated with) the housing 503. As explained above, the term “base” for the base light fixture 502 of FIGS. 5A and 5B conveys that the light fixture 502 is capable of connecting to one or more detachable modules without actually being connected to any detachable modules at that point in time.

The base light fixture 502 of FIGS. 5A and 5B is substantially the same as the base light fixture 302 of FIGS. 3A and 3B above, except as described below. For example, the base light fixture 502 of FIGS. 5A and 5B can include a connecting assembly 590 that is configured to connect to and/or receive a detachable module (e.g., detachable module 270). In this case, while the connecting assembly 590 includes two connecting features 594, the connecting assembly 590 does not includes a receiving cavity (e.g., receiving cavity 392). Instead, the two connecting features 594 are recessed with respect to and disposed adjacent to the bottom surface of the housing 503 of the base light fixture 502.

Also, the housing 503 of the base light fixture 502 can include one or more walls that form a cavity 501. The cavity 501 formed by the walls of the housing 503 can have disposed therein one or more components 589 related to the operation of the base light fixture 502. In this case, the component 589 is completely enclosed within cavity 501 of the housing 503. In addition, the component 589 of the base light fixture 502 of FIGS. 5A and 5B is directly coupled (connected) to both of the connecting features 594 of the connecting assembly 590.

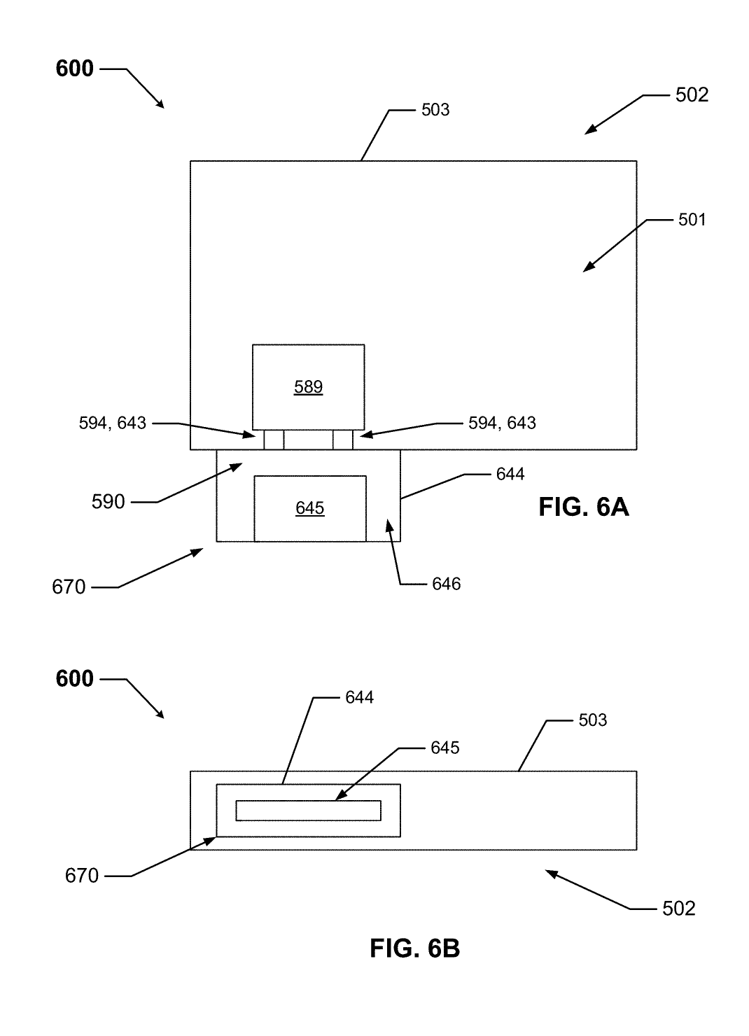

FIGS. 6A and 6B show another integrated light fixture 600 that includes a detachable module 690 coupled to the base light fixture 502 of FIGS. 5A and 5B in accordance with certain example embodiments. Specifically, FIG. 6A shows a cross-sectional side view of the integrated light fixture 600. FIG. 6B shows a bottom view of the integrated light fixture 600. Referring to FIGS. 1-6B, the integrated light fixture 600 (including its various components) of FIGS. 6A and 6B can be substantially the same as the integrated light fixture 400 (including its corresponding various components) discussed above with respect to FIGS. 4A and 4B. For example, the detachable module 670 of FIGS. 6A and 6B can include a housing 644, one or more (in this case, two) connecting features 643 that extend from the top wall of the housing 644, and a component 645 disposed within a cavity 646 formed by the housing 644.

With the integrated light fixture 600, the detachable module 670 is connected to (coupled to) the connecting assembly 590 of the base light fixture 502. When this occurs, as shown in FIGS. 6A and 6B, the housing 644 of the detachable module 670 is disposed entirely outside the housing 503 of the base light fixture 502, although the top surface of the detachable module 670 abuts against (or comes into close contact with) the bottom surface of the housing 503 of the base light fixture 502. In addition, when the detachable module 670 is connected to (coupled to) the connecting assembly 590 of the base light fixture 502, the component 645 of the detachable module 670 can become electrically coupled, using one or more of the coupling features 643 of the detachable module 670 and one or more coupling features 594 of the connecting assembly 590 of the base light fixture 502, to the component 589 (e.g., a controller) disposed in the housing 503 of the base light fixture 502.

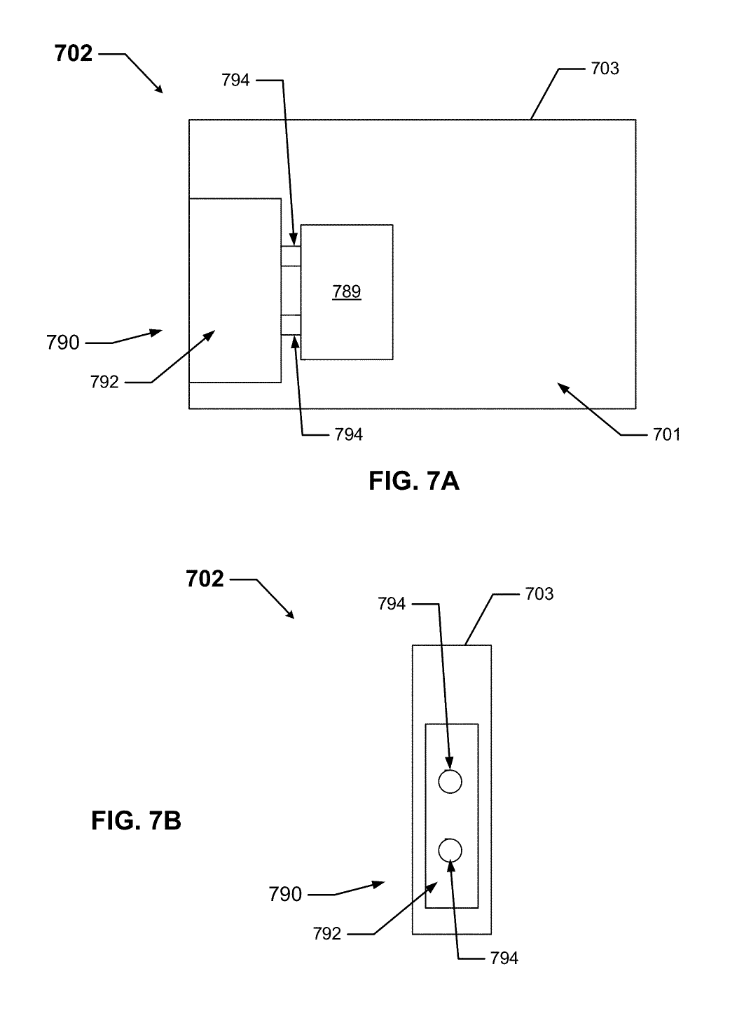

FIGS. 7A and 7B show yet another base light fixture 702 in accordance with certain example embodiments. Specifically, FIG. 7A shows a cross-sectional side view of the base light fixture 702. FIG. 7B shows a bottom view of the base light fixture 702. Referring to FIGS. 1-7B, the example base light fixture 702 of FIGS. 7A and 7B can include a housing 703 and one or more connecting assemblies 790 that are recessed into (or are otherwise integrated with) the housing 703. As explained above, the term “base” for the base light fixture 702 of FIGS. 7A and 7B conveys that the light fixture 702 is capable of connecting to one or more detachable modules without actually being connected to any detachable modules at that point in time.

The base light fixture 702 of FIGS. 7A and 7B includes a connecting assembly 790 that is configured to connect to and/or receive a detachable module (e.g., detachable module 270). In this case, the connecting assembly 790 includes two connecting features 794 and a receiving cavity 792. In this case, receiving cavity 792 and the two connecting features 794 are recessed with respect to and disposed adjacent to a side (in this case, the left side) surface of the housing 703 of the base light fixture 702.

Also, the housing 703 of the base light fixture 702 in this case includes multiple walls that form a cavity 701. The cavity 701 formed by the walls of the housing 703 have disposed therein a component 789 related to the operation of the base light fixture 702. In this case, the component 789 (e.g., power supply 940 of FIG. 9 below) is completely enclosed within cavity 701 of the housing 703. In addition, the component 789 of the base light fixture 702 of FIGS. 7A and 7B is directly coupled (connected) to both of the connecting features 794 of the connecting assembly 790. In some cases, as when the connecting assembly 790 is used solely for mounting of the base light fixture 702, there may be no component 789 coupled to the connecting features 794.

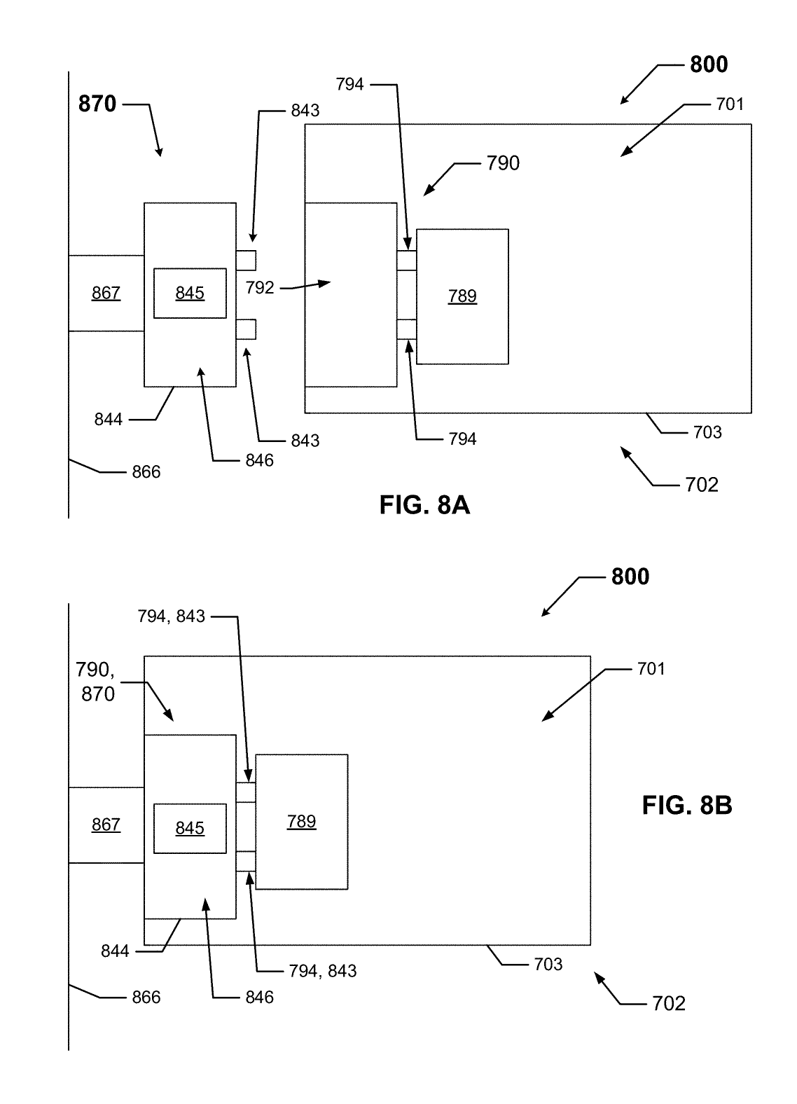

FIGS. 8A and 8B shows yet another integrated light fixture 800 that includes a detachable module 870 and the base light fixture 702 of FIGS. 7A and 7B in accordance with certain example embodiments. Specifically, FIG. 8A shows a cross-sectional side view of the integrated light fixture 800. FIG. 8B shows a bottom view of the integrated light fixture 800. Referring to FIGS. 1-8B, the integrated light fixture 800 (including its various components) of FIGS. 8A and 8B can be substantially the same as the integrated light fixtures discussed above. For example, the detachable module 870 of FIGS. 8A and 8B can include a housing 844, one or more (in this case, two) connecting features 843 that extend from the right side wall of the housing 844, and a component 845 disposed within a cavity 846 formed by the housing 844. In this case, the detachable module 870 is coupled to an extension 867, which is coupled to a platform 866 (e.g., a wall, a pole, a pillar). The left side surface of the detachable module 870 is coupled to the extension 867. If the detachable module 870 is used solely to mount the base light fixture 702, then the detachable module 870 may not include a component 845.

With the integrated light fixture 800, the detachable module 870 is connected to (coupled to) the connecting assembly 790 of the base light fixture 702. When this occurs, as shown in FIGS. 8A and 8B, the housing 844 of the detachable module 870 is disposed entirely within the housing 703 of the base light fixture 702. In addition, when the detachable module 870 is connected to (coupled to) the connecting assembly 790 of the base light fixture 702, the component 845 of the detachable module 870 can become electrically coupled, using one or more of the coupling features 843 of the detachable module 870 and one or more coupling features 794 of the connecting assembly 790 of the base light fixture 702, to the component 789 (e.g., a power supply) disposed in the housing 703 of the base light fixture 702.

FIG. 9 shows a system diagram of a lighting system 909 that includes at least one integrated light fixture 900 in accordance with certain example embodiments. The lighting system 909 can include the integrated light fixture 900, a power source 995, one or more users 950, and a network manager 980. The integrated light fixture 900 can include one or more detachable modules 970 (also called removable modules 970 herein) and the base light fixture 902. The base light fixture 902 can include a controller 904, one or more optional energy storage devices 979, at least one power supply 940, and at least one light source 942. The controller 904 can include one or more of a number of components. As shown in FIG. 9, such components can include, but are not limited to, a control engine 906, a communication module 908, a timer 910, an energy metering module 911, a power module 912, a storage repository 930, a hardware processor 920, a memory 922, a transceiver 924, an application interface 926, and, optionally, a security module 928. The components shown in FIG. 9 are not exhaustive, and in some embodiments, one or more of the components shown in FIG. 9 may not be included in an example integrated light fixture 900. Any component of the example integrated light fixture 900 can be discrete or combined with one or more other components of the integrated light fixture 900.

A user 950 can be any person that interacts with light fixtures. Examples of a user may include, but are not limited to, an engineer, an electrician, an instrumentation and controls technician, a mechanic, an operator, a consultant, an inventory management system, an inventory manager, a foreman, a labor scheduling system, a contractor, and a manufacturer's representative. The user 950 can use a user system (not shown), which may include a display (e.g., a GUI). The user 950 interacts with (e.g., sends data to, receives data from) the controller 904 of the integrated light fixture 900 via the application interface 926 (described below).

The user 950 can also interact with a network manager 980 and/or one or more of the detachable modules 970. Interaction between the user 950 and the base light fixture 902, the network manager 980, the power source 995, and the detachable modules 970 can be conducted using communication links 905. Each communication link 905 can include wired (e.g., Class 1 electrical cables, Class 2 electrical cables, electrical connectors, power line carrier, DALI, RS485) and/or wireless (e.g., Wi-Fi, visible light communication, cellular networking, Bluetooth, WirelessHART, ISA100) technology. For example, a communication link 905 can be (or include) one or more electrical conductors that are coupled to the housing 903 (a type of enclosure) of the base light fixture 902 and to a detachable module 970. The communication link 905 can transmit signals (e.g., power signals, communication signals, control signals, data) between the base light fixture 902 and the user 950, the network manager 980, the power source 995, and/or one or more of the detachable modules 970.

The network manager 980 is a device or component that controls all or a portion of a communication network that includes the controller 904 of the base light fixture 902, additional light fixtures, and the detachable modules 970 that are communicably coupled to the controller 904. The network manager 980 can be substantially similar to the controller 904. Alternatively, the network manager 980 can include one or more of a number of features in addition to, or altered from, the features of the controller 904 described below. As described herein, communication with the network manager 980 can include communicating with one or more other components (e.g., another light fixture) of the system 909. In such a case, the network manager 980 can facilitate such communication.

The power source 995 of the system 909 provides AC mains or some other form of power to the base light fixture 902, as well as to one or more other components (e.g., the network manager 980) of the system 909. The power source 995 can include one or more of a number of components. Examples of such components can include, but are not limited to, an electrical conductor, a coupling feature (e.g., an electrical connector), a transformer, an inductor, a resistor, a capacitor, a diode, a transistor, and a fuse. The power source 995 can be, or include, for example, a wall outlet, an energy storage device (e.g. a battery, a supercapacitor), a circuit breaker, and/or an independent source of generation (e.g., a photovoltaic solar generation system). The power source 995 can also include one or more components (e.g., a switch, a relay, a controller) that allow the power source 995 to communicate with and/or follow instructions from the user 950, the controller 904, and/or the network manager 980.

An optional energy storage device 979 can be any of a number of rechargeable batteries or similar storage devices that are configured to charge using some source of power (e.g., the primary power provided to the light fixture, ultraviolet rays). The energy storage device 979 can use one or more of any type of storage technology, including but not limited to a battery, a flywheel, an ultracapacitor, and a supercapacitor. If the energy storage device 979 includes a battery, the battery technology can vary, including but not limited to lithium ion, nickel-cadmium, lead/acid, solid state, graphite anode, titanium dioxide, nickel cadmium, nickel metal hydride, nickel iron, alkaline, and lithium polymer. In some cases, one or more of the energy storage devices 979 charge using a different level and/or type of power relative to the level and type of power of the primary power. In such a case, the power supply 979 can convert, invert, transform, and/or otherwise manipulate the primary power to the level and type of power used to charge the energy storage devices 979. There can be any number of energy storage devices 979.

A detachable module 970 is directly coupled to one or more connecting assemblies 990 disposed on the housing 903 of the base light fixture 902. Alternatively, as shown in FIGS. 4A, 6A, and 8B above, a detachable module 970 can be coupled to one or more connecting assemblies 990 disposed within the housing 903 of the base light fixture 902, Each connecting assembly 990 (including components thereof) of the base light fixture 902 of FIG. 9 can be substantially the same as the connecting assemblies (including corresponding components thereof) of the base light fixtures discussed above. For example, each connecting feature 943 of a detachable module 970 can be substantially the same as the connecting features of the detachable modules discussed above. The base light fixture 902 can have any of a number of connecting assemblies 990, where each connecting assembly 990 can be positioned at any location on or within the housing 903 of the base light fixture 902.

The housing 944 of a detachable module 970 can also include or be coupled to an extension (e.g., extension 867), which can be used, for example, for mounting purposes. If the extension is a separate piece that is coupled to the housing 944 of the detachable module 970, one or more of a number of coupling features (e.g., bolts, epoxy, slots, apertures) can be used to allow the extension and the housing 944 of the detachable module 970 to be directly or indirectly coupled to each other.

As discussed above, a detachable module 970 can include one or more of any number of optional components 945 that can be used in the operation of the integrated light fixture 900 and/or another light fixture in the system 909. Alternatively, a component 945 of a detachable module 970 can be unrelated to the operation of the integrated light fixture 900. As an example, a component 945 of the detachable module 970 can be one or more of any type of sensing device that measures one or more parameters. In such a case, examples of types of sensor devices can include, but are not limited to, a passive infrared sensor, a photocell, a pressure sensor, an air flow monitor, a gas detector, and a resistance temperature detector. A parameter that can be measured by a sensor device of a detachable module 970 can include, but is not limited to, motion, an amount of ambient light, humidity, air quality, vibration, occupancy of a volume of space, pressure, air flow, smoke (as from a fire), temperature (e.g., excessive heat, excessive cold, an ambient temperature).

In some cases, when a component 945 of the detachable module 970 is a sensor device, the detachable module 970 can be include a bezel, a lens, and/or any of a number of other components to enhance the performance of the sensor device. In some cases, the parameter or parameters measured by a component of a detachable module 970 that is a sensor device can be used to operate one or more light sources 942 of the light fixture 902. Alternatively, the component 945 of a detachable module 970 can be used for some other purpose (e.g., security) that is independent of the operation of the light fixture 902.

As another example, a component 945 of a detachable module 970 can be one or more components of the base light fixture 902 that are shown in FIG. 9 and described above. For example, a component 945 of the detachable module 970 can be a light source 942, an energy storage device 979, a transceiver 924, or a power supply 940. In this way, the detachable module 970 can replace or supplement one or more of the components of the base light fixture 902. As yet another example, a component 945 of a detachable module 970 can be a camera or other image capture device. As still another example, a component 945 of a detachable module 970 can be a Wi-Fi repeater module or other similar device used for wireless communication. When a component 945 of a detachable module 970 is a communication device (e.g., a Wi-Fi repeater module, a beacon), the component 945 can use one or more of a number of communication protocols.

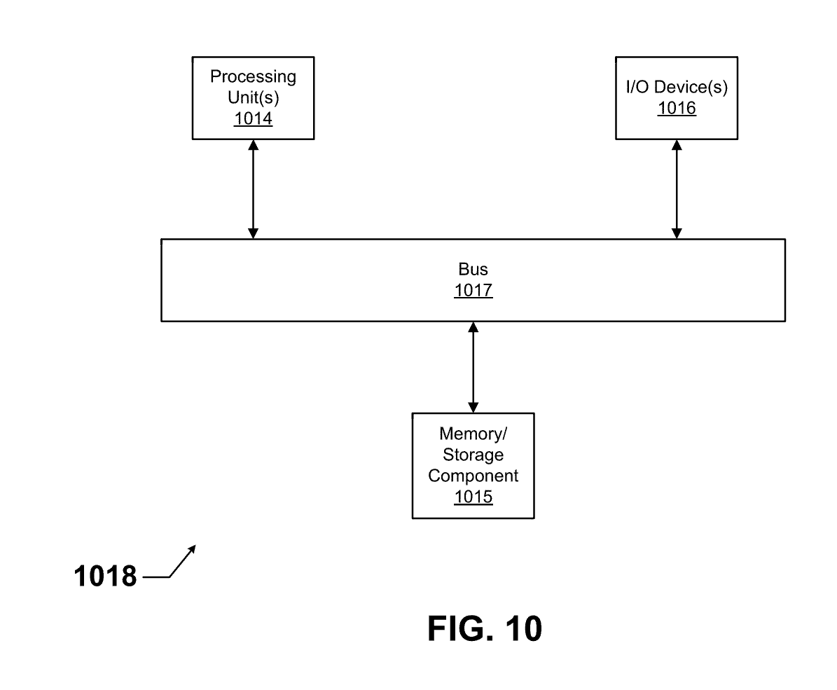

A component 945 of a detachable module 970 can include an energy storage device (e.g., a battery) that is used to provide power, at least in part, to some or all of the detachable module 970. In such a case, the energy storage device can be the same as, or independent of, the energy storage device 979, described above, of the base light fixture 902. The energy storage device of the detachable module 970 can operate at all times or when a primary source of power to the base light fixture 902 is interrupted. Further, a detachable module 970 can utilize or include one or more components (e.g., memory 922, storage repository 930, transceiver 924) found in the controller 904 of the base light fixture 902. In such a case, the controller 904 can provide the functionality of these components used by the detachable module 970. Alternatively, the detachable module 970 can include, either on its own or in shared responsibility with the controller 904, one or more of the components of the controller 904. In such a case, the detachable module 970 can correspond to a computer system as described below with regard to FIG. 10.

The user 950, the network manager 980, the power source 995, and/or the detachable modules 970 can interact with the controller 904 of the base light fixture 902 using the application interface 926 in accordance with one or more example embodiments. Specifically, the application interface 926 of the controller 904 receives data (e.g., information, communications, instructions, updates to firmware) from and sends data (e.g., information, communications, instructions) to the user 950, the network manager 980, the power source 995, and/or each detachable module 970. The user 950, the network manager 980, the power source 995, and/or each detachable module 970 can include an interface to receive data from and send data to the controller 904 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

The controller 904, the user 950, the network manager 980, the power source 995, and/or the detachable modules 970 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 904. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 10.

Further, as discussed above, such a system can have corresponding software (e.g., user software, sensor software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 909.

The base light fixture 902 can include a housing 903. The housing 903 can include at least one wall that forms a cavity 901. In some cases, the housing can be designed to comply with any applicable standards so that the base light fixture 902 can be located in a particular environment (e.g., indoors, outdoors, high humidity). The housing 903 of the base light fixture 902 can be used to house one or more components of the base light fixture 902, including one or more components of the controller 904. For example, as shown in FIG. 9, the controller 904 (which in this case includes the control engine 906, the communication module 908, the timer 910, the energy metering module 911, the power module 912, the storage repository 930, the hardware processor 920, the memory 922, the transceiver 924, the application interface 926, and the optional security module 928), the optional energy storage devices 979, the power supply 940, and the light sources 942 are disposed in the cavity 901 formed by the housing 903. In alternative embodiments, any one or more of these or other components of the base light fixture 902 can be disposed on the housing 903 and/or remotely from the housing 903.

The storage repository 930 can be a persistent storage device (or set of devices) that stores software and data used to assist the controller 904 in communicating with the user 950, the network manager 980, the power source 995, and one or more detachable modules 970 within the system 909. In one or more example embodiments, the storage repository 930 stores one or more communication protocols 932, algorithms 933, and stored data 934. The communication protocols 932 can be any of a number of protocols that are used to send and/or receive data between the controller 904 and the user 950, the network manager 980, the power source 995, and one or more detachable modules 970.

For example, when a detachable module 970 is coupled to the base light fixture 902, the controller 904 can use one or more communication protocols 932 to establish communications with the detachable module 970 (including a component 945 thereof), identify the detachable module 970 and its operating parameters, and provide power and/or control signals at the appropriate level (e.g., 12V, 120V) and of the appropriate type (e.g., alternating current, direct current) for the detachable module 970 to operate properly.

One or more of the communication protocols 932 can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the communication protocols 932 can provide a layer of security to the data transferred within the system 909.

The algorithms 933 can be any formulas, mathematical models, forecasts, simulations, and/or other similar tools that the control engine 906 of the controller 904 uses based on certain conditions at a point in time. An example of an algorithm 933 is measuring (using the energy metering module 911), storing (using the stored data 934 in the storage repository 930), and evaluating the current and voltage delivered to and delivered by the power supply 940 over time.

Stored data 934 can be any data associated with the base light fixture 902 (including other light fixtures and/or any components thereof), any measurements taken (e.g., by a component 945 of the detachable modules 970 when the component 945 is a sensor device), measurements taken by the energy metering module 911, threshold values, results of previously run or calculated algorithms, and/or any other suitable data. Such data can be any type of data, including but not limited to historical data, calculations, actual measurements, and forecasts. The stored data 934 can be associated with some measurement of time derived, for example, from the timer 910.

Examples of a storage repository 930 can include, but are not limited to, a database (or a number of databases), a file system, a hard drive, flash memory, some other form of solid state data storage, or any suitable combination thereof. The storage repository 930 can be located on multiple physical machines, each storing all or a portion of the communication protocols 932, the algorithms 933, and/or the stored data 934 according to some example embodiments. Each storage unit or device can be physically located in the same or in a different geographic location.

The storage repository 930 can be operatively connected to the control engine 906. In one or more example embodiments, the control engine 906 includes functionality to communicate with the user 950, the network manager 980, the power source 995, and the detachable modules 970 in the system 909. More specifically, the control engine 906 sends information to and/or receives information from the storage repository 930 in order to communicate with the user 950, the network manager 980, the power source 995, and the detachable modules 970. As discussed below, the storage repository 930 can also be operatively connected to the communication module 908 in certain example embodiments.

In certain example embodiments, the control engine 906 of the controller 904 controls the operation of one or more components (e.g., the communication module 908, the timer 910, the transceiver 924) of the controller 904. For example, the control engine 906 can activate the communication module 908 when the communication module 908 is in “sleep” mode and when the communication module 908 is needed to send data received from another component (e.g., a detachable module 970, the user 950) in the system 909.

As another example, the control engine 906 can acquire the current time using the timer 910. The timer 910 can enable the controller 904 to control the base light fixture 902 even when the controller 904 has no communication with the network manager 980. As yet another example, when a detachable module 970 is coupled to the base light fixture 902, the controller 904 (e.g., using one or more communication protocols 932) can establish communications with the detachable module 970 (including a component 945 thereof), identify the detachable module 970 and its operating parameters, and provide power and/or control signals at the appropriate level (e.g., 12V, 120V) and of the appropriate type (e.g., alternating current, direct current) for the detachable module 970 to operate properly. This can occur regardless of whether the controller 904 is directly connected to the connecting features (e.g., connecting features 794) of the connecting assembly 990.

The control engine 906 can provide control, communication, and/or other similar signals to the user 950, the network manager 980, the power source 995, and one or more of the detachable modules 970. Similarly, the control engine 906 can receive control, communication, and/or other similar signals from the user 950, the network manager 980, the power source 995, and one or more of the detachable modules 970. The control engine 906 can control each detachable module 970 automatically (for example, based on one or more algorithms stored in the control engine 906) and/or based on control, communication, and/or other similar signals received from another device through a communication link 905. The control engine 906 may include a printed circuit board, upon which the hardware processor 920 and/or one or more discrete components of the controller 904 are positioned.

In certain embodiments, the control engine 906 of the controller 904 can communicate with one or more components of a system external to the system 909. For example, the control engine 906 can interact with an inventory management system by ordering a detachable module (or one or more components thereof) to replace the detachable module 970 (or one or more components thereof) that the control engine 906 has determined to fail or be failing. As another example, the control engine 906 can interact with a workforce scheduling system by scheduling a maintenance crew to repair or replace the detachable module 970 (or portion thereof) when the control engine 906 determines that the detachable module 970 or portion thereof requires maintenance or replacement. In this way, the controller 904 is capable of performing a number of functions beyond what could reasonably be considered a routine task.

In certain example embodiments, the control engine 906 can include an interface that enables the control engine 906 to communicate with one or more components (e.g., power supply 940) of the base light fixture 902. For example, if the power supply 940 of the base light fixture 902 operates under IEC Standard 62386, then the power supply 940 can have a serial communication interface that will transfer data (e.g., stored data 934) measured by the detachable modules 970. In such a case, the control engine 906 can also include a serial interface to enable communication with the power supply 940 within the base light fixture 902. Such an interface can operate in conjunction with, or independently of, the communication protocols 932 used to communicate between the controller 904 and the user 950, the network manager 980, the power source 995, and the detachable modules 970.

The control engine 906 (or other components of the controller 904) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The communication module 908 of the controller 904 determines and implements the communication protocol (e.g., from the communication protocols 932 of the storage repository 930) that is used when the control engine 906 communicates with (e.g., sends signals to, receives signals from) the user 950, the network manager 980, the power source 995, and/or one or more of the detachable modules 970. In some cases, the communication module 908 accesses the stored data 934 to determine which communication protocol is used to communicate with the detachable module 970 associated with the stored data 934. In addition, the communication module 908 can interpret the communication protocol of a communication received by the controller 904 so that the control engine 906 can interpret the communication.

The communication module 908 can send and receive data between the network manager 980, the power source 995, the detachable modules 970, the users 950, and the controller 904. The communication module 908 can send and/or receive data in a given format that follows a particular communication protocol 932. The control engine 906 can interpret the data packet received from the communication module 908 using the communication protocol 932 information stored in the storage repository 930. The control engine 906 can also facilitate the data transfer between one or more detachable modules 970 and the network manager 980 or a user 950 by converting the data into a format understood by the communication module 908.

The communication module 908 can send data (e.g., communication protocols 932, algorithms 933, stored data 934, operational information, alarms) directly to and/or retrieve data directly from the storage repository 930. Alternatively, the control engine 906 can facilitate the transfer of data between the communication module 908 and the storage repository 930. The communication module 908 can also provide encryption to data that is sent by the controller 904 and decryption to data that is received by the controller 904. The communication module 908 can also provide one or more of a number of other services with respect to data sent from and received by the controller 904. Such services can include, but are not limited to, data packet routing information and procedures to follow in the event of data interruption.

The timer 910 of the controller 904 can track clock time, intervals of time, an amount of time, and/or any other measure of time. The timer 910 can also count the number of occurrences of an event, whether with or without respect to time. Alternatively, the control engine 906 can perform the counting function. The timer 910 is able to track multiple time measurements concurrently. The timer 910 can track time periods based on an instruction received from the control engine 906, based on an instruction received from the user 950, based on an instruction programmed in the software for the controller 904, based on some other condition or from some other component, or from any combination thereof.

The timer 910 can be configured to track time when there is no power delivered to the controller 904 (e.g., the power module 912 malfunctions) using, for example, an energy storage device 979. In such a case, when there is a resumption of power delivery to the controller 904, the timer 910 can communicate any aspect of time to the controller 904. In such a case, the timer 910 can include one or more of a number of components (e.g., a super capacitor, an integrated circuit) to perform these functions.

The optional energy metering module 911 of the controller 904 measures one or more components of power (e.g., current, voltage, resistance, VARs, watts) at one or more points within the base light fixture 902. The energy metering module 911 can include any of a number of measuring devices and related devices, including but not limited to a voltmeter, an ammeter, a power meter, an ohmmeter, a current transformer, a potential transformer, and electrical wiring. The energy metering module 911 can measure a component of power continuously, periodically, based on the occurrence of an event, based on a command received from the control module 906, and/or based on some other factor. For purposes herein, the energy metering module 911 can be considered a type of sensor (e.g., detachable module 970). In this way, a component of power measured by the energy metering module 911 can be considered a parameter herein.

The power module 912 of the controller 904 provides power to one or more other components (e.g., timer 910, control engine 906) of the controller 904. In addition, in certain example embodiments, the power module 912 can provide power to the power supply 940 of the base light fixture 902. The power module 912 can include one or more of a number of single or multiple discrete components (e.g., transistor, diode, resistor), and/or a microprocessor. The power module 912 may include a printed circuit board, upon which the microprocessor and/or one or more discrete components are positioned. In some cases, the power module 912 can include one or more components that allow the power module 912 to measure one or more elements of power (e.g., voltage, current) that is delivered to and/or sent from the power module 912, Alternatively, the controller 904 can include a power metering module (not shown) to measure one or more elements of power that flows into, out of, and/or within the controller 904. Such a power metering module can also be considered a type of sensor device herein.

The power module 912 can include one or more components (e.g., a transformer, a diode bridge, an inverter, a converter) that receives power (for example, through an electrical cable) from a source external to the base light fixture 902 and generates power of a type (e.g., alternating current, direct current) and level (e.g., 12V, 24V, 120V) that can be used by the other components of the controller and/or by the power supply 940. The power module 912 can use a closed control loop to maintain a preconfigured voltage or current with a tight tolerance at the output. The power module 912 can also protect the rest of the electronics (e.g., hardware processor 920, transceiver 924) in the base light fixture 902 from surges generated in the line.

In addition, or in the alternative, the power module 912 can be a source of power in itself to provide signals to the other components of the controller 904 and/or the power supply 940. For example, the power module 912 can be a battery. As another example, the power module 912 can be a localized photovoltaic power system. The power module 912 can also have sufficient isolation in the associated components of the power module 912 (e.g., transformers, opto-couplers, current and voltage limiting devices) so that the power module 912 is certified to provide power to an intrinsically safe circuit.

In certain example embodiments, the power module 912 of the controller 904 can also provide power and/or control signals, directly or indirectly, to one or more of the detachable modules 970. In such a case, the control engine 906 can direct the power generated by the power module 912 to the detachable modules 970. In this way, the appropriate type and level of power, as determined by the control engine 906, can be delivered to the detachable modules 970 when needed.

The hardware processor 920 of the controller 904 executes software, algorithms, and firmware in accordance with one or more example embodiments. Specifically, the hardware processor 920 can execute software on the control engine 906 or any other portion of the controller 904, as well as software used by the user 950, the network manager 980, the power source 995, and/or one or more of the detachable modules 970. The hardware processor 920 can be an integrated circuit, a central processing unit, a multi-core processing chip, SoC, a multi-chip module including multiple multi-core processing chips, or other hardware processor in one or more example embodiments. The hardware processor 920 is known by other names, including but not limited to a computer processor, a microprocessor, and a multi-core processor.

In one or more example embodiments, the hardware processor 920 executes software instructions stored in memory 922. The memory 922 includes one or more cache memories, main memory, and/or any other suitable type of memory. The memory 922 can include volatile and/or non-volatile memory. The memory 922 is discretely located within the controller 904 relative to the hardware processor 920 according to some example embodiments. In certain configurations, the memory 922 can be integrated with the hardware processor 920.

In certain example embodiments, the controller 904 does not include a hardware processor 920. In such a case, the controller 904 can include, as an example, one or more field programmable gate arrays (FPGA), one or more insulated-gate bipolar transistors (IGBTs), one or more integrated circuits (ICs). Using FPGAs, IGBTs, ICs, and/or other similar devices known in the art allows the controller 904 (or portions thereof) to be programmable and function according to certain logic rules and thresholds without the use of a hardware processor. Alternatively, FPGAs, IGBTs, ICs, and/or similar devices can be used in conjunction with one or more hardware processors 920.

The transceiver 924 of the controller 904 can send and/or receive control and/or communication signals. Specifically, the transceiver 924 can be used to transfer data between the controller 904 and the user 950, the network manager 980, the power source 995, and/or the detachable modules 970. The transceiver 924 can use wired and/or wireless technology. The transceiver 924 can be configured in such a way that the control and/or communication signals sent and/or received by the transceiver 924 can be received and/or sent by another transceiver that is part of the user 950, the network manager 980, the power source 995, and/or the detachable modules 970. The transceiver 924 can use any of a number of signal types, including but not limited to radio signals.

When the transceiver 924 uses wireless technology, any type of wireless technology can be used by the transceiver 924 in sending and receiving signals. Such wireless technology can include, but is not limited to, Wi-Fi, visible light communication, cellular networking, and Bluetooth. The transceiver 924 can use one or more of any number of suitable communication protocols (e.g., ISA100, HART) when sending and/or receiving signals. Such communication protocols can be stored in the communication protocols 932 of the storage repository 930. Further, any transceiver information for the user 950, the network manager 980, the power source 995, and/or the detachable modules 970 can be part of the stored data 934 (or similar areas) of the storage repository 930.

Optionally, in one or more example embodiments, the security module 928 secures interactions between the controller 904, the user 950, the network manager 980, the power source 995, and/or the detachable modules 970. More specifically, the security module 928 authenticates communication from software based on security keys verifying the identity of the source of the communication. For example, user software may be associated with a security key enabling the software of the user 950 to interact with the controller 904 and/or the detachable modules 970. Further, the security module 928 can restrict receipt of information, requests for information, and/or access to information in some example embodiments.

As mentioned above, aside from the controller 904 and its components, the base light fixture 902 can include a power supply 940 and one or more light sources 942. The light sources 942 of the base light fixture 902 are devices and/or components typically found in a light fixture to allow the base light fixture 902 to operate. The base light fixture 902 can have one or more of any number and/or type of light sources 942. Examples of such light sources 942 can include, but are not limited to, a local control module, a light source, a light engine, a heat sink, an electrical conductor or electrical cable, a terminal block, a lens, a diffuser, a reflector, an air moving device, a baffle, a dimmer, and a circuit board. A light source 942 can use any type of lighting technology, including but not limited to LED, incandescent, sodium vapor, and fluorescent.

The power supply 940 of the base light fixture 902 provides power to one or more of the light sources 942 and, in some cases, the detachable module 970. The power supply 940 can be called by any of a number of other names, including but not limited to a driver, a LED driver, and a ballast. The power supply 940 can be substantially the same as, or different than, the power module 912 of the controller 904. The power supply 940 can include one or more of a number of single or multiple discrete components (e.g., transistor, diode, resistor), and/or a microprocessor. The power supply 940 may include a printed circuit board, upon which the microprocessor and/or one or more discrete components are positioned, and/or a dimmer.

The power supply 940 can include one or more components (e.g., a transformer, a diode bridge, an inverter, a converter) that receives power (for example, through an electrical cable) from the power module 912 of the controller 904 and generates power of a type (e.g., alternating current, direct current) and level (e.g., 12V, 24V, 920V) that can be used by the light sources 942 and/or the detachable modules 970. In addition, or in the alternative, the power supply 940 can receive power from a source external to the base light fixture 902. In addition, or in the alternative, the power supply 940 can be a source of power in itself. For example, the power supply 940 can be a battery, a localized photovoltaic power system, or some other source of independent power.

As stated above, the base light fixture 902 can be placed in any of a number of environments. In such a case, the housing 903 of the base light fixture 902 can be configured to comply with applicable standards for any of a number of environments. For example, the housing 903 of a base light fixture 902 can be rated as a Division 1 or a Division 2 enclosure under NEC standards. Similarly, any of the detachable modules 970 or other devices communicably coupled to the base light fixture 902 can be configured to comply with applicable standards for any of a number of environments. For example, a detachable module 970 can be rated as a Division 1 or a Division 2 enclosure under NEC standards.

FIG. 10 illustrates one embodiment of a computing device 1018 that implements one or more of the various techniques described herein, and which is representative, in whole or in part, of the elements described herein pursuant to certain exemplary embodiments. Computing device 1018 is one example of a computing device and is not intended to suggest any limitation as to scope of use or functionality of the computing device and/or its possible architectures. Neither should computing device 1018 be interpreted as having any dependency or requirement relating to any one or combination of components illustrated in the example computing device 1018.

Computing device 1018 includes one or more processors or processing units 1014, one or more memory/storage components 1015, one or more input/output (I/O) devices 1016, and a bus 1017 that allows the various components and devices to communicate with one another. Bus 1017 represents one or more of any of several types of bus structures, including a memory bus or memory controller, a peripheral bus, an accelerated graphics port, and a processor or local bus using any of a variety of bus architectures. Bus 1017 includes wired and/or wireless buses.

Memory/storage component 1015 represents one or more computer storage media. Memory/storage component 1015 includes volatile media (such as random access memory (RAM)) and/or nonvolatile media (such as read only memory (ROM), flash memory, optical disks, magnetic disks, and so forth). Memory/storage component 1015 includes fixed media (e.g., RAM, ROM, a fixed hard drive, etc.) as well as removable media (e.g., a Flash memory drive, a removable hard drive, an optical disk, and so forth).

One or more I/O devices 1016 allow a customer, utility, or other user to enter commands and information to computing device 1018, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 1018 is connected to a network (not shown) (e.g., a local area network (LAN), a wide area network (WAN) such as the Internet, cloud, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 1018 includes at least the minimal processing, input, and/or output means necessary to practice one or more embodiments.

Further, those skilled in the art will appreciate that one or more elements of the aforementioned computer device 1018 is located at a remote location and connected to the other elements over a network in certain exemplary embodiments. Further, one or more embodiments is implemented on a distributed system having one or more nodes, where each portion of the implementation (e.g., control engine 906) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

Example embodiments can allow for increased design flexibility among electrical devices (e.g., light fixtures). Example embodiments promote a modular approach to building electrical devices (e.g., light fixtures) without having to have a number of varying specially-designed electrical devices. Example embodiments can be used with electrical devices that are located in any of a number of environments. Example embodiments, allow for modular configurations of an electrical device (or portions thereof) while allowing the electrical device to comply with applicable standards. Such a feature allows for flexible designs, both electrically and mechanically.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A lighting system comprising:
a light fixture comprising:
a fixture housing comprising at least one fixture wall that forms a fixture cavity, wherein the fixture housing further comprises a first connecting feature disposed in the at least one fixture wall; and
a first light fixture component disposed within the fixture cavity and electrically connected to the first connecting feature; and
a first module removably connected to the light fixture, wherein the first module comprises:
a first module housing comprising at least one first device wall and a second connecting feature disposed in the at least one first device wall, wherein the second connecting feature is removably connected to the first connecting feature; and
a first module component that is electrically connected to the first light fixture component when the first connecting feature and the second connecting feature are connected to each other.

2. The lighting system of claim 1, wherein the first module component of the first module comprises a light source.

3. The lighting system of claim 1, wherein the first module component of the first module comprises a sensor.

4. The lighting system of claim 1, wherein the first module component of the first module comprises a camera.

5. The lighting system of claim 1, wherein the first module component of the first module comprises a communication device.

6. The lighting system of claim 1, wherein the first module component of the first module comprises a power supply for the light fixture.

7. The lighting system of claim 6, wherein the first module further serves as a mount for the light fixture relative to a structure.

8. The lighting system of claim 1, wherein the first light fixture component comprises a controller.

9. The lighting system of claim 8, wherein the controller automatically recognizes and enables the first module when the first module becomes connected to the light fixture.

10. The lighting system of claim 1, further comprising:
a second module removably connected to the light fixture, wherein the second module comprises:
a second device housing comprising at least one second device wall and a third connecting feature disposed in the at least one device wall, wherein the second connecting feature is removably connected to a fourth connecting feature disposed in the at least one fixture wall of the light fixture housing,
wherein the second component is used to operate the light fixture.

11. The lighting system of claim 1, wherein the first module is connected to and unconnected from the light fixture without using tools.

12. The lighting system of claim 1, wherein the first module is seamlessly integrated into the fixture housing of the light fixture when the first module is connected to the light fixture.

13. A light fixture comprising:
a housing comprising at least one wall that forms a cavity, wherein the housing further comprises a first connecting feature disposed in the at least one wall;
a first lighting system component disposed within the cavity and electrically connected to the first connecting feature,
wherein the first connecting feature is configured to be removably connected to a first module, wherein the first module, when connected to the first connecting feature, is connected to the first lighting system component.

14. The light fixture of claim 13, wherein the housing further comprises a second connecting feature disposed in the at least one wall, wherein the second connecting feature is configured to be removably connected to a second module, wherein the second module, when connected to the second connecting feature, is connected to the first lighting system component and is used to operate the light fixture.

15. The light fixture of claim 13, wherein the housing further comprises a second connecting feature disposed in the at least one wall, wherein the second connecting feature is configured to be removably connected to a second module, wherein the second module, when connected to the second connecting feature, is connected to a second lighting system component disposed within the cavity of the housing, wherein the second module is used to operate the light fixture.

16. The light fixture of claim 13, wherein the housing further comprises a second connecting feature disposed in the at least one wall, wherein the second connecting feature is configured to be removably connected to the first module, wherein the first module is configured to be connected to the first connecting feature and the second connecting feature simultaneously.

17. The light fixture of claim 13, further comprising:
a blank removably connected to the housing, wherein the blank protects the first connecting feature when the first module is unconnected from the first connecting feature.

18. The light fixture of claim 13, wherein the first connecting feature is disposed along a bottom edge of the housing.

19. A detachable module for a light fixture, the module comprising:
a housing comprising at least one wall that forms a cavity, wherein the housing further comprises a connecting feature disposed in the at least one wall;
a component disposed within the cavity and electrically connected to the connecting feature,
wherein the connecting feature is configured to be detachably connected to a complementary coupling feature of the light fixture,
wherein the housing, when connected to the light fixture, is seamlessly integrated with a light fixture housing of the light fixture.

20. The detachable module of claim 19, wherein the component comprises at least one selected from a group consisting of an ancillary light source, a camera, a communication device, a power supply, and a detachable module.
